(19) United States
(12) Patent Application Publication
(10) Pub. No.: US 2012/0031759 A1
(43) Pub. Date: Feb. 9, 2012

(54) DIELECTROPHORETIC DEVICE WITH ACTUATOR

(75) Inventors: Monika Hausmann, Kusterdingen (DE); Meike Moschallski, Reutlingen (DE); Anton Posch, Grafing (DE); Martin Stelzle, Reutlingen (DE); Joerg Kentsch, Tubingern (DE); Simon Werner, Gomaringen (DE)

(73) Assignees: Natural and Medical Sciences Institute at the University of Tubingen, Reutlingen (DE); Bio-Rad Laboratories, Inc., Hercules, CA (US)

(21) Appl. No.: 13/145,540

(22) PCT Filed: Jan. 30, 2009
(86) PCT No.: PCT/US09/32622

§ 371 Date: Oct. 11, 2011

(51) Int. Cl. B03C 5/02

(52) U.S. Cl. 204/547; 204/643

(57) ABSTRACT

A dielectrophoretic fractionation device having a channel defining a direction of flow therethrough for the fractionation of particles in a liquid particle suspension is disclosed. The device also has a deflector unit affixed to a wall of the channel and arranged to generate an electric field gradient in the channel to spatially separate the particles in the liquid particle suspension. The device also has an actuator mounted to the channel and positioned to deform the wall. Also provided is a method for inhibiting aggregation of particles in a liquid particle suspension of the dielectrophoretic fractionation device, the method including periodically deforming the wall with the actuator.

### BACKGROUND OF THE INVENTION

Prior art methods for the fractionation of subcellular particles have a variety of drawbacks that prevent them from providing large quantities of pure material. These methods include subcellular fractionation by gradient centrifiigation, Free Flow Electrophoresis (FFE), isoelectric focusing in microfluidic devices, and current dielectrophoretic (DEP) separation procedures. Dielectrophoretic band pass structures are known in the state of the art, which allow for separation of a particular particle fraction from a complex suspension of particles. (WO 99/52640, EP01069955B1, U.S. Pat. No. 6,727,451, and related EP01089823B1, U.S. Pat. No. 6,749,736B1). WO 01/05513 A1 teaches the combination of ultrasonic actuation and dielectrophoresis for particle manipulation in liquid media. A standing ultrasonic wave is created in the channel in such a way that particles accumulate either in regions of maximum or minimum amplitude, i.e., either in the middle of the channel or close to its walls, where they may be further manipulated by DEP.

However, these methods all suffer from a variety of limitations, such as dilution of sample, the need for subsequent concentration of fractions, and the fact that they are time consuming, tedious, or require skilled personnel. The current dielectrophoretic separation methods specifically suffer from low throughput, high electric fields, small channel cross sections, complex fluidic design, and incompatibility with biological “real world” samples (containing e.g. nucleic acids, membrane fragments and cell debris) because these constituents contribute to electrode fouling by the formation of aggregates that lead to blocking of channels.

What is needed is a device for the separation of subcellular particles that provides continuous fractionation of cell or tissue homogenates (in general complex biological samples containing for example DNA, protein, membrane fragments) and collection of particular cell organelles, along with high yield and high throughput, and that inhibits electrode fouling. Surprisingly, the present invention meets these and other needs.

### BRIEF SUMMARY OF THE INVENTION

In one embodiment, the present invention provides a dielectrophoretic fractionation device for the fractionation of particles in a liquid particle suspension, the device having a channel defining a direction of flow therethrough. The device has a deflector unit affixed to a wall of the channel and arranged to generate an electric field gradient in the channel to spatially separate the particles in the liquid particle suspension. The device also has an actuator mounted to the channel and positioned to deform the wall.

In another embodiment, the present invention provides a method for inhibiting aggregation of particles in a liquid particle suspension of a dielectrophoretic fractionation device of the present invention, the method including periodically deforming the wall with the actuator.

### BRIEF DESCRIPTION OF THE DRAWINGS

FIG. 1 shows a cross section view, (FIG. 1a), and a top view, (FIG. 1b), of the dielectrophoretic fractionation device of the present invention. A combination of dielectrophoretic and mechanical actuation creates an oscillating fluid flow that is superimposed onto the laminar flow. Vibrations of the channel wall due to the incompressibility of the medium are transferred to particles in the liquid particle suspension such that the vibrations mobilize the particles and inhibit aggregate formation.

FIG. 2 shows the various forces influencing the particles in the liquid particle suspension and under the influence of the electric field gradient. As particles in the liquid particle suspension approaches the field gradient, a dipole moment is induced in the particle giving rise to a repulsive dielectrophoretic force, F_{DEP}, slowing down the particle with respect to the liquid movement. This in turn results in a hydrodynamic friction force (Stokes friction), F_{HD}, which is directed in the direction of liquid movement. If the component of F_{HD} oriented perpendicular to the electrode, F_{HD}^{⊥} is larger than F_{DEP}, particles are dragged through the deflector unit. In contrast, if F_{HD}^{⊥} is smaller than F_{DEP}, particles move along the edge of the electrodes towards the tip of the deflector unit, where the component of F_{HD} oriented in parallel to the electrode, F_{HD}⁼ provides the driving force for this movement. Since F_{DEP} (proportional to r³) and F_{HD} (proportional to r) scale differently with the particle radius, for large particles F_{DEP}>F_{HD}, whereas for small particles F_{DEP}<F_{HD}. The dielectrophoretic force, F_{DEP}, depends on the dielectric properties of the particle and the liquid particle suspension, and can be tuned by varying the voltage amplitude and frequency of the alternating current (AC) applied to the deflector unit. The hydrodynamic friction force, F_{HD}, can be varied by varying the velocity of liquid flow.

FIG. 3 shows a schematic of a dielectrophoretic fractionation device of the present invention.

FIG. 4 shows a schematic of a dielectrophoretic fractionation device of the present invention with a plurality of sequentially arranged deflector units. FIG. 4a shows a layout with sequentially arranged electrode arrays of the dielectrophoretic band pass. FIG. 4b shows a layout with arrays of deflector electrodes with different lengths for the simultaneous separation of several particle fractions from a sample.

FIG. 5a shows a pictorial representation of a dielectrophoretic fractionation device of the present invention mounted in its fixture. FIG. 5b shows a schematic depiction of the experimental setup comprising a fluorescence microscope with camera (CAM), syringe pumps (SP 1-3), valves (V 1-3), high frequency generators (FG 1, FG 2), amplifier (AMP), multiplexer (MP), mechanical actuators and provisions for cooling both the microsystem and the biological samples.

FIG. 6 shows a CAD design of a dielectrophoretic fractionation device of the present invention with wide channel design and deflector electrode arrays arranged to form a dielectrophoretic band pass structure along with fluorescence micrographs acquired at the locations indicated by the black dots. Bright fluorescence indicates streams of mitochondria labeled with JC-1 dye. The fluorescence micrographs show a liquid particle suspension having a certain concentration of particles prior to contacting the electric field gradient of the deflector units, the deflection of particles at the deflector units, the absence of particles in the liquid particle suspension that has passed the deflector units, and the concentration of particles at the sample collection point.

FIG. 7 shows a diagram (FIG. 7a) and picture (FIG. 7b) of the piezo-electric actuator of the present invention.

FIG. 8 shows the results of a Western Blot demonstrating that the dielectrophoretic device of the present invention can isolate mitochondrial protein in the presence of endoplasmic reticulum (ER) and lysosomes.

FIG. 9 shows the impedance properties for a device of the present invention where the deflector unit is (a) electro-polished; (b) untreated; or (c) coated with PEG.

FIG. 10 shows an immuno-stained gel where the purity of the first sample prepared below is compared to a sample purified by the device and method of the present invention. The sample purified by the device and method of the present invention shows reduced concentration of lysosome (LAMP being a marker for lysosomes) and Endoplasmic reticulum (BiP being a marker for Endoplasmic reticulum) and increased concentration of mitochondria (VDAC marker).

### DETAILED DESCRIPTION OF THE INVENTION

### I. General

The present invention provides a dielectrophoretic fractionation device for the fractionation of particles in a liquid particle suspension where the device inhibits the formation of particle aggregates. Aggregate formation is inhibited by vibrations in the device formed by means of periodically deforming the device using an actuator in such a way that the vibrations cause a periodic change of the channel height, which, because of the incompressibility of the liquid, causes liquid movement in the channel plane. Accordingly, the dielectrophoretic fractionation device of the present invention can separate biological particles such as organelles, including mitochondria, from homogenate of LCL cells (human lymphoblastoid cell line).

In a preferred embodiment, robust long-term (several days) and high throughput operation of the dielectrophoretic fractionation device of the present invention using complex real-world biological samples is possible using one or more of the following: 1) coating of the deflector units, 2) use of an actuator to induce periodic flow patterns, 3) cooling of the dielectrophoretic fractionation device in combination with a heat sink to keep any temperature increases due to Joule heating in a safe range and ensure integrity and viability of the particles, and 4) a dedicated channel layout exhibiting large channel width to provide for high fluidic throughput.

### II. Definitions

As used herein, the term “dielectrophoretic fractionation device” refers to a device that fractionates particles according to the size, shape and/or the dielectric properties of the particles, using a non-uniform electric field.

As used herein, the term “liquid particle suspension” refers to a liquid containing a suspension of particles. The liquid can be any known liquid, such as an aqueous liquid, and can optionally include sugars, buffers, salts, acids and bases.

As used herein, the term “deflector unit” refers to a pair of electrodes positioned to create an electric field gradient when a voltage is applied across the electrodes, such that particles of a certain size, shape and/or dielectric property coming into contact with the electric field gradient are deflected in one direction. The electrodes of the deflector unit can be on the same wall or on opposing walls.

As used herein, the term “actuator” refers to a portion of the dielectrophoretic fractionation device of the present invention that periodically deforms a wall of the channel to create an oscillating fluid flow superimposed onto the laminar flow of the liquid particle suspension. The wall can be periodically deformed by physically striking the wall with a mechanical actuator, or by deforming the wall with a hydraulic, magnetic or piezo-electric actuator.

As used herein, the term “coating” refers to the covering of a surface by a material. The coating of the device of the present invention inhibits interaction of the particles with the deflector units of the device. The coating can be prepared from biological materials, organic materials such as polymers, or metal coatings.

As used herein, the term “inhibit” refers to a process that impedes and retards the formation of particle aggregates.

As used herein, the term “heat sink” refers to an environment or object that is capable of absorbing and dissipating heat from another environment or object using thermal contact.

As used herein, the term “thermally conductive material” refers to a material that is capable of transferring thermal energy from one environment or object to another by conduction. Thermally conductive materials include, but are not limited to, metals, semi-metals, semiconductors, and certain organic materials.

As used herein, the term “aggregation” refers to a collection of particles that have affixed to each other through means other than covalent bonding.

As used herein, the term “periodically deforming” refers to a temporary deformation that occurs at a regular frequency. The wall that is being deformed is not permanently deformed, but is resilient and returns to its non-deformed shape when the stress or pressure causing the deformation is removed.

### III. Dielectrophoretic Fractionation Device

The present invention provides a dielectrophoretic fractionation device for the fractionation of particles in a liquid particle suspension. The device includes a channel defining a direction of flow therethrough, a deflector unit affixed to a wall of the channel and arranged to generate an electric field gradient in the channel to spatially separate the particles in the liquid particle suspension, and an actuator mounted to the channel and positioned to deform the wall.

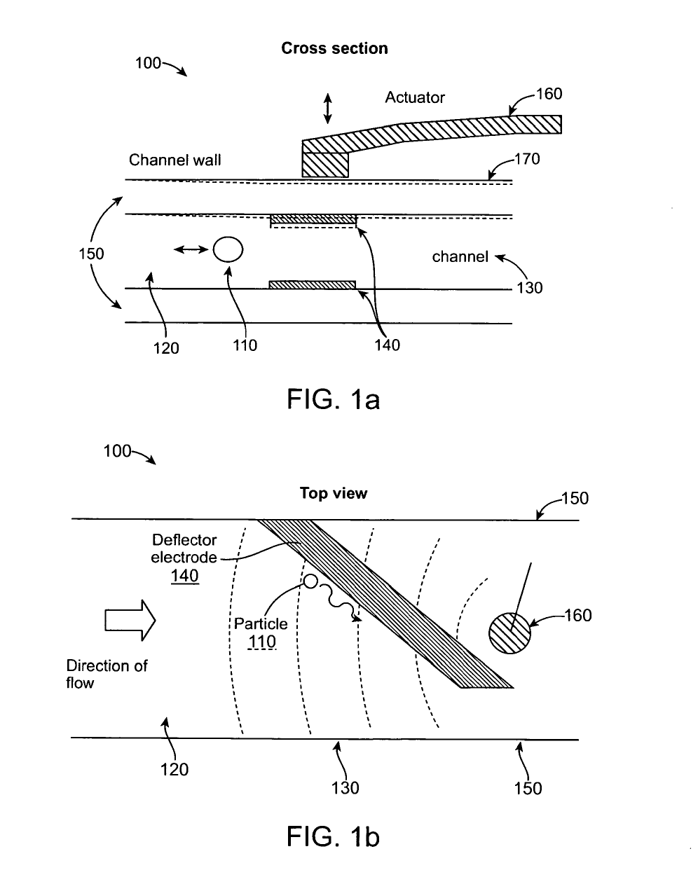

FIG. 1 shows one embodiment of the dielectrophoretic fractionation device of the present invention. The dielectrophoretic fractionation device 100 includes a channel 130 through which the particles 110 and liquid particle suspension 120 flow. The dielectrophoretic fractionation device also includes a deflector unit 140 that is affixed to channel wall 150. The deflector unit 140 includes two electrodes between which an electric field gradient can be generated to spatially separate the particles in the liquid particle suspension. An actuator 160 is mounted to the channel and positioned to deform the wall. In some embodiments, the actuator 160 is affixed to an outside surface 170 of the wall 150. In other embodiments, the actuator 160 is positioned to strike the outside surface 170 of the wall 150.

The particles 110 of the dielectrophoretic fractionation device of the present invention can be any suitable particles, such as biological or synthetic particles. In some embodiments, the particles are biological, such as subcellular particles including organelles. Subcellular particles include, but are not limited to, nucleolus, nucleus, ribosome, vesicle, endoplasmic reticulum, the Golgi apparatus, cytoskeleton, mitochondria, peroxisome, chloroplast, glyoxysome, autophagosome, vacuole, cytosol, lysosome and centriole. Other particles will be readily apparent to those skilled in the art. The particles can be any suitable size, from about 100 nm to about 100 μm in diameter.

The liquid particle suspension 120 flows through the channel carrying the particles from an inlet to an outlet. The liquid particle suspension can include any suitable liquid for carrying the particles, such as an aqueous liquid. The liquid particle suspension can also include sugars, buffers, salts, acids and bases. The composition of the liquid particle suspension is dependent on the particle to be isolated, and is such that there is a difference in the permittivity between the particle and the liquid particle suspension. The permittivity of the liquid particle suspension can be adjusted by the addition of sugars, such as sucrose, buffers, salts, acids and bases. In some embodiments, the liquid particle suspension can include at least one of a sugar such as sucrose, ethylenediaminetetraacetic acid (EDTA), or 3-(N-morpholino)propanesulfonic acid (MOPS). In other embodiments, the liquid particle suspension is basic. In some other embodiments, the liquid particle suspension contains 300 mM sucrose, 1 mM EDTA, 20 mM MOPS, and is at pH 7.4.

The channel 130 of the dielectrophoretic fractionation device of the present invention can be any suitable width. In some embodiments, the channel is from about 500 μm to about 50 mm wide. In other embodiments, the channel is from about 1 mm to about 20 mm wide. In some other embodiments, the channel is from about 5 mm to about 15 mm wide. In still other embodiments, the channel is about 5, 6, 7, 8, 9, 10, 11, 12, 13, 14 or 15 mm wide.

The channel 130 of the dielectrophoretic fractionation device of the present invention can be any suitable height. In some embodiments, the channel is from about 1 μm to about 100 μm high. In other embodiments, the channel is from about 1 μm to about 50 μm high. In some other embodiments, the channel is from about 5 μm to about 50 μm high. In still other embodiments, the channel is from about 5 μm to about 20 μm high. In yet other embodiments, the channel is about 5, 6, 7, 8, 9, 10, 11, 12, 13, 14, 15, 16, 17, 18, 19 or 20 μm high. The height of the channel can also be determined by the average diameter of the particle to be isolated. In some embodiments, the channel height is about 3 to about 30 times the average diameter of the particle to be isolated.

The channel 130 of the dielectrophoretic fractionation device of the present invention can have any suitable flow rate. In some embodiments, the flow rate of the liquid particle suspension is from about 0.01 μL/min to about 1000 μL/min. In other embodiments, the flow rate of the liquid particle suspension is from about 0.1 μL/min to about 100 μL/min. In some other embodiments, the flow rate of the liquid particle suspension is from about 0.5 μL/min to about 10 μL/min. In still other embodiments, the flow rate of the liquid particle suspension is about 0.5, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5 or 10.0 μL/min. In yet other embodiments, the flow rate of the liquid particle suspension is sufficient to provide micrograms of fractionated particles in several hours from samples at a concentration of about 1 μg/mL to about 1 mg/mL

The channel can be prepared from a variety of materials, with each segment of the channel, such as the top, bottom, and/or the walls of the channel, prepared from the same or a different material. Materials suitable for the channel include, but are not limited to, glass, metals, silicon, and polymers. Examples of polymers suitable in the channel of the present invention include, but are not limited to, elastomers (such as polyisoprene, polybutadiene, polychloroprene, polyisobutylene, poly(styrene-butadiene-styrene), polyurethanes, and silicones), cycloolefin copolymers, methacrylates (PMMA), polyamide (PA), polypropylene, polyethylene, polystyrene and thermally conductive polymers. Examples of cycloolefin copolymers include, but are not limited to, Topas® (an ethylene/norbornene copolymer) and Zeonex®. Thermally conductive polymers also include thermoplasts containing at least 60% of metallic or ceramic filler materials. Examples of thermally conductive polymers include, but are not limited to, CoolPoly® D-series—Thermally Conductive Dielectric Plastics, and CoolPoly®—Thermally Conductive Elastomers. Other materials will be readily apparent to those skilled in the art.

The channel can be prepared by a variety of methods known to one of skill in the art. In some embodiments, the channel is divided into a top half and a bottom half, such that both halves are prepared from the same material. In other embodiments, the top half and the bottom half of the channel are prepared from separate materials. In some other embodiments, the top half includes a cycloolefin copolymer, such as Topas®, and the bottom half includes a thermally conductive material such as silicon.

Deflector unit 140 includes a pair of electrodes that are affixed to either the same wall or on opposing walls inside the channel. The dielectrophoretic fractionation device of the present invention can include one deflector unit or a plurality of deflector units. The electrodes of each deflector unit can be prepared from any suitable conducting material, such as a metal including, but not limited to, platinum and gold. In some embodiments, the electrode is gold, or coated with gold. The electrodes of the deflector unit can be prepared by a variety of methods known to one of skill in the art, such as photolithography or thin film deposition methods (such as vapor deposition or plasma deposition) or a combination thereof.

The electrodes of the deflector unit can be of any suitable width. In some embodiments, the electrodes are from about 0.1 μm to about 1000 μm wide. In other embodiments, the electrodes are from about 1 pμm to about 500 μm wide. In some other embodiments, the electrodes are from about 5 μm to about 100 μm wide.

The electrodes of the deflector unit can be of any suitable length. In some embodiments, the electrodes are from about 0.1 mm to about 100 mm long. In other embodiments, the electrodes are from about 1 mm to about 50 mm long. In some embodiments, the electrodes are from about 1 mm to about 20 mm long. In still other embodiments, the electrodes are about 1, 2, 3, 4, 5, 6, 7, 8, 9, 10, 11, 12, 13, 14, 15, 16, 17, 18, 19 or 20 mm long.

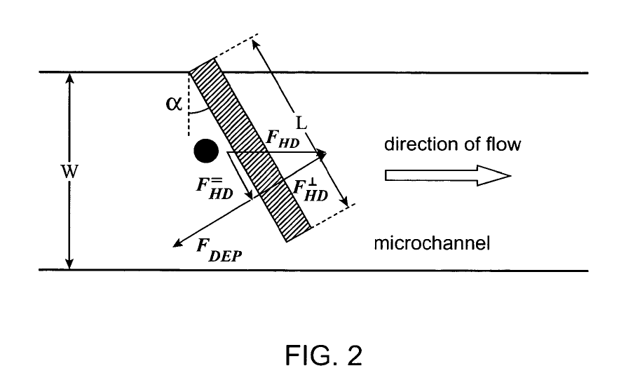

The deflector unit can be affixed to a wall of the channel and oriented at a variety of angles (α of FIG. 2) to the flow of the liquid particle suspension. In some embodiments, the angle α is between about 30° and about 80°. In other embodiments, the angle α is between about 50° and 70°. In some other embodiments, the angle α is about 60°. In still other embodiments, the electrodes of the deflector unit are affixed to a top wall and a bottom wall (when the electrodes of the deflector unit are on opposing walls of the channel). In yet other embodiments, the deflector unit is affixed to the surface of the wall of the channel such that the deflector unit protrudes into the flow of the liquid particle suspension. In still yet other embodiments, the deflector unit is recessed in the wall of the channel

The deflector unit is arranged such that when a voltage is applied to the deflector unit, an electric field gradient is generated between the two electrodes of the deflector unit. A variety of voltages are suitable in the dielectrophoretic fractionation device of the present invention. The voltage creates an electric field gradient that is of sufficient strength to influence the movement of the particles in the liquid particle suspension based on a variety of factors including the size of the particles, the shape of the particles and the dielectrophoretic properties of the particles. Thus, the electric field gradient spatially separates the particles in the liquid particle suspension. In some embodiments, the voltage is from about 0.1 V to about 500 V. In other embodiments, the voltage is from about 1 V to about 100 V. In some other embodiments, the voltage is from about 10 V to about 35 V. In still other embodiments, the voltage can be 10, 11, 12, 13, 14, 15, 16, 17, 18, 19, 20, 21, 22, 23, 24, 25, 26, 27, 28, 29, 30, 31, 32, 33, 34, or 35 V. The voltage used for the device and method of the present invention can be applied using a direct current or an alternating current. When the voltage is generated using the alternating current, the alternating current can be applied using a frequency from about 1 Hz to about 10⁹ Hz. In some embodiments, the frequency is from about 10³ to about 10⁷ Hz. In other embodiments, the frequency is from about 10⁴ to about 10⁶ Hz. In some other embodiments, the frequency is from about 10⁵ to about 10⁶ Hz.

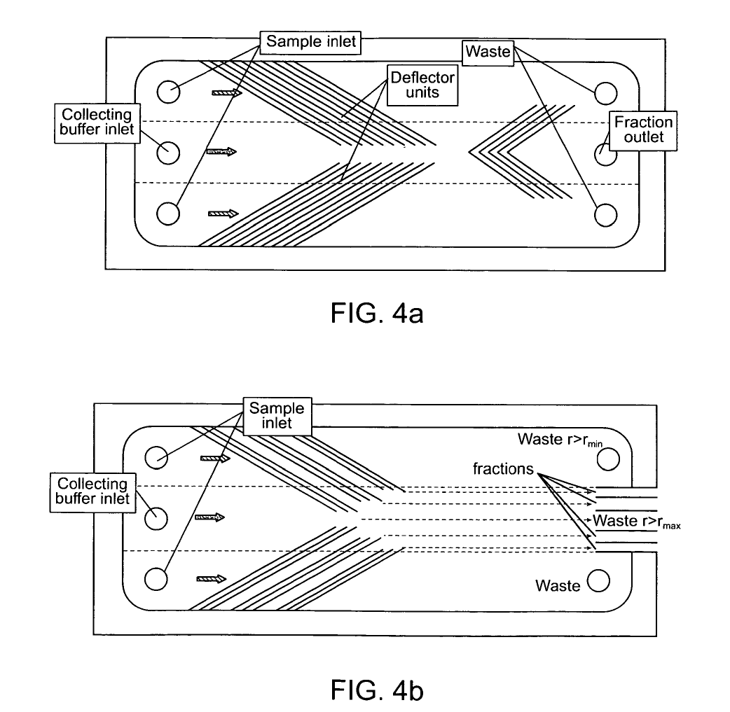

In some embodiments, the dielectrophoretic fractionation device of the present invention includes a plurality of deflector units (FIG. 4a). When a plurality of deflector units is present, each deflector unit can be a different length and width, and be oriented to the flow of the liquid particle suspension at different angles. The deflector units can also adopt a variety of geometries, such as a line, a chevron, or others. When the deflector units have different lengths (FIG. 4b), each set of deflector units at a particular length can be used to isolate a specific particle size. Thus, by using several sets of deflector units, where each set of deflector units has a different length, and by controlling the voltage applied to each deflector unit, particles of different sizes can be simultaneously isolated.

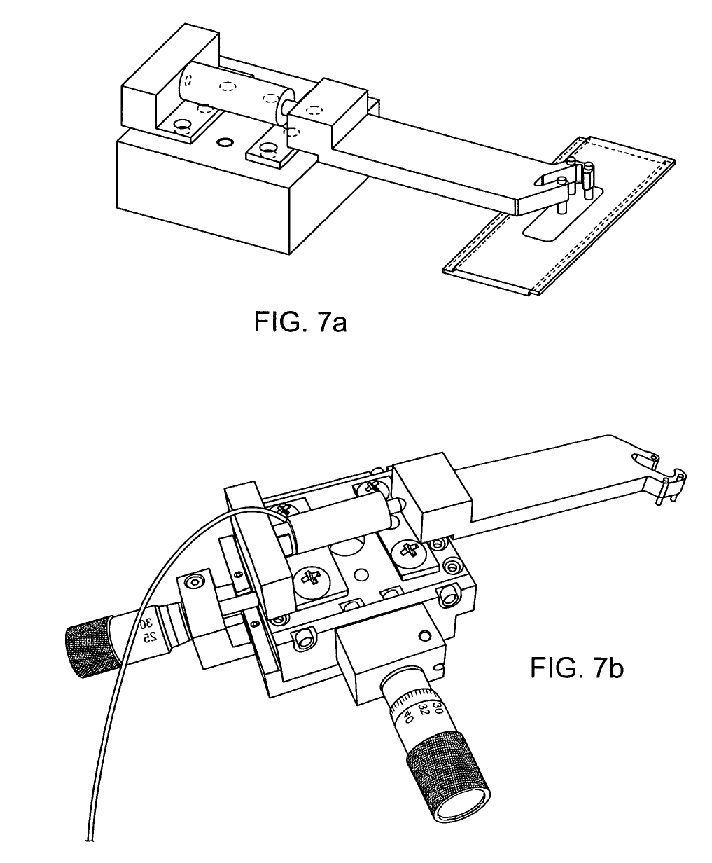

The dielectrophoretic fractionation device of the present invention also includes an actuator 160 mounted to the channel and positioned to deform the wall. The actuator can be prepared from any suitable material. In some embodiments, the actuator is a metal, or a mixture of a metal with other materials to form an alloy. In other embodiments, the actuator is a polymer. In some other embodiments, the actuator is a composite. Examples of actuators are mechanical actuators, magnetic actuators, hydraulic actuators and piezoelectric actuators. When the actuator is a piezoelectric actuator, the actuator can be controlled by electric signals (see FIG. 7). The actuator can be positioned such that the actuator deforms any portion of the wall of the channel. In some embodiments, the actuator is positioned to deform the wall downstream of the deflector unit. In other embodiments, the actuator is positioned to deform the wall upstream of the deflector unit. In still further embodiments, the actuator is positioned to deform the wall coincident with the deflector unit.

The channel wall is deformed to a degree sufficient to cause an oscillating fluid flow that is superimposed onto the laminar flow of the liquid particle suspension, as a result of vibrations of the channel wall and due to the incompressibility of the medium. In some embodiments, a deformation that is sufficient to cause the oscillating fluid flow is from about 10 nm to about 10 μm. In other embodiments, the deformation is from about 100 nm to about 1 μm.

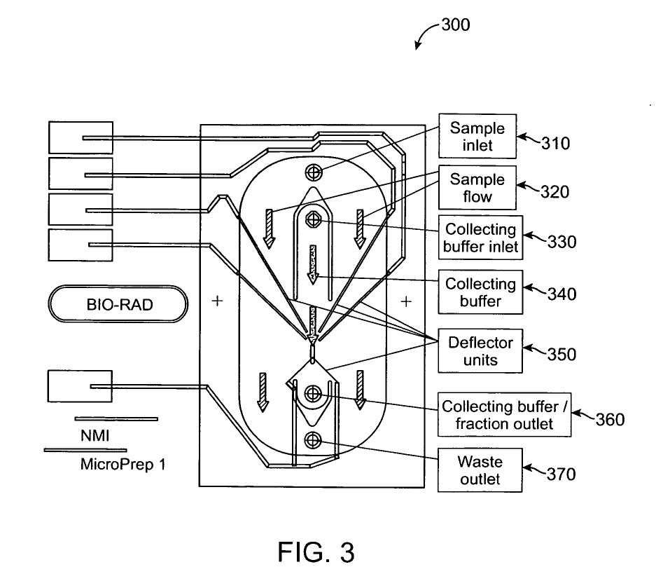

FIG. 3 shows another embodiment of the dielectrophoretic fractionation device of the present invention. The dielectrophoretic fractionation device of the present invention can include two halves, an upper half and a lower half, which are arranged in such a way that the deflector units are exactly positioned on top of each other. FIG. 3 shows a sample inlet 310 where the particles to be fractionated are introduced and a collecting buffer inlet 330 where the collecting buffer 340 is introduced. The particles flow 320 from the sample inlet 310 in the liquid particle suspension towards the fraction outlet 360 and waste outlet 370, encountering the electric field gradient along the way. The electric field gradient is generated at the deflector units 350 by applying a voltage to the deflector units such that an electric field gradient forms. The electric field gradient is tuned by the amplitude and frequency of the voltage to apply the maximum dielectrophoretic forces onto the particles of the desired size. As the particles of the desired size interact with the electric field gradient, the particles move laterally along the length of the deflector unit. When the particles reach the end of the deflector unit 350, the particles continue moving towards the collection outlet 360. For the particles that are not of the desired size, the dielectrophoretic forces are not sufficient to prevent the particles from passing through the electric field gradient, and these particles continue flowing through the electric field gradient and are collected by the waste outlet 370.

In some embodiments, the dielectrophoretic fractionation device of the present invention also includes a coating affixed to the deflector unit to inhibit the interaction of the particles with the deflector unit. The coating can be any substance that inhibits the interaction of the particles with the deflector unit, such as biological materials or polymers. The coating inhibits the adsorption of the particles on the deflector unit. In other embodiments, the coating is bovine serum albumin (BSA) or a polyethylene glycol (PEG) polymer. In some other embodiments, the PEG can have an average molecular weight of about 200 to about 10,000. In yet other embodiments, the PEG can have an average molecular weight of about 1,000 to about 5,000. In still other embodiments, the PEG can have an average molecular weight of about 3,000.

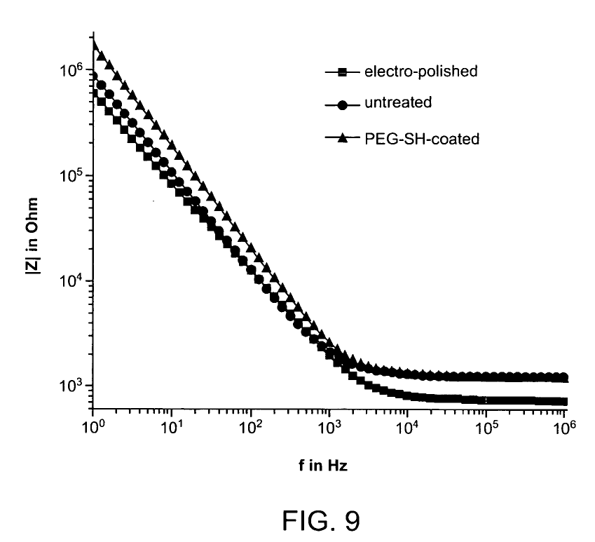

The coating of the deflector units can be applied by any means known in the art. For example, the PEG can be functionalized with a thiol group and then adsorbed onto gold coated electrodes of the deflector units. Impedance spectroscopy (FIG. 9) shows an increased impedance for a deflector unit coated with PEG, demonstrating that the deflector unit is coated with PEG. In addition, the BSA can be coated onto the deflector units by physical adsorption (electrostatic, hydrophobic, or van der Waals interaction) thus inhibiting further adsorption of other proteins and particles.

In some embodiments, the dielectrophoretic fractionation device also includes a heat sink affixed to a second wall of the channel. The heat sink removes heat from the second (bottom) wall of the channel, thereby controlling the temperature of the liquid particle suspension in the channel. Materials suitable for the heat sink include any metal, such as copper or aluminum. Other thermally conductive materials, such as thermally conductive polymers, are also useful as the heat sink.

In order to conduct heat from the liquid particle suspension to the heat sink, the second wall of the channel can include a thermally conductive material. Thermally conductive materials useful in the second wall of the channel include, but are not limited to, glass, silicon, metals, composites, carbon nanotube compounds and thermally conductive polymers. In the case of thermally conducting materials that are also electrically conducting, a thin insulator, such as a silicon dioxide layer when the thermally conducting material is silicon, can be applied between the wall and the deflector electrodes. Examples of thermally conductive polymers include, but are not limited to, polyesters, elastomers, polyolefins, polycarbonates, polyurethanes, and combinations thereof. Composites include the thermally conductive polymers above, or other polymer materials, mixed with metal, ceramic or semiconductor powder to provide for heat conductive properties. Other thermally conductive materials and polymers are useful in the present invention. In some embodiments, the second wall includes silicon or a metal, with a layer of silicon dioxide or other suitable insulating material (including, for example, a thin layer of polyimide) in order to be electrically insulating.

### IV. Method for Inhibiting Aggregation

The present invention also provides a method for inhibiting aggregation of particles in a liquid particle suspension of a dielectrophoretic fractionation device as described above, where the method includes periodically deforming the wall with the actuator.

In some embodiments, the frequency with which the wall is deformed is from about 0.1 Hz to about 1000 Hz. In other embodiments, the frequency is from about 0.5 Hz to about 500 Hz. In some other embodiments, the frequency is from about 1 Hz to about 100 Hz. In still other embodiments, the frequency is from about 1 Hz to about 10 Hz. In yet other embodiments, the frequency is 1, 2, 3, 4, 5, 6, 7, 8, 9, or 10 Hz. When the actuator is mechanical and deforms the wall by striking the wall, the actuator of the present invention can strike the outside surface of the channel with a force between about 0.1 N and 10 N. In some embodiments, the force is about 1 N.

The dielectrophoretic fractionation device is periodically rinsed of any aggregates by suspending or accelerating the flow of the liquid particle suspension, in combination with stopping the flow of particles into the channel, turning off the voltage to the deflector unit, and increasing the frequency with which the actuator deforms the wall. For example, the frequency of deformation can be greater than 10 Hz when the aggregates are rinsed out.

In some embodiments, aggregation of particles is inhibited by the use of a deflector unit that is coated to inhibit the interaction of the particles with the deflector unit, as described above.

In other embodiments, aggregation of particles is inhibited by maintaining the temperature of the liquid particle suspension at from about 0° C. to about 40° C. In some other embodiments, the temperature is maintained at from about 0° C. to about 10° C. In still other embodiments, the temperature is maintained at about 0, 1, 2, 3, 4, 5, 6, 7, 8, 9, or 10° C.

The samples used in the method of the present invention can be any suitable sample containing particles to be isolated. The samples can include biological material, such as subcellular organelles. In some embodiments, the sample is prepared from lymphoblastoid suspension cells with a concentration of 5-10×10⁸ per prep, where the mitochondria are labeled with the fluorescent dye JC-1. The lymphoblastoid cells are centrifuged twice at 1080×gravity for 8 minutes each, with a washing in between with 100 mM sucrose, 1 mM EDTA, 20 mM MOPS, at pH 7.4 (Medium A). The pellets are resuspended in 1 mL of a solution containing 0.01% Digitonin, 100 mM sucrose, 1 mM EDTA, 20 mM MOPS, at pH 7.4, and incubated for 5 minutes at room temperature (Medium B). The sample is then dounced (150×) in Medium B at 4° C. After centrifugation twice at 1300×gravity for 10 minutes each time, the post-nuclear supernatant (PNS) is separated and diluted with 300 mM sucrose, 1 mM EDTA, 20 mM MOPS, 1× protease inhibitor, at pH 7.4 (Medium C). The sample is again centrifuged at 10,000×gravity for 10 minutes. The pellet containing the mitochondria is then isolated and washed in 1.5 mL Medium C followed by centrifugation at 10,000×gravity for 10 minutes to provide a first sample (M1) to be used in the method of the present invention, the sample having a protein concentration of about 10-200 ng/μL.

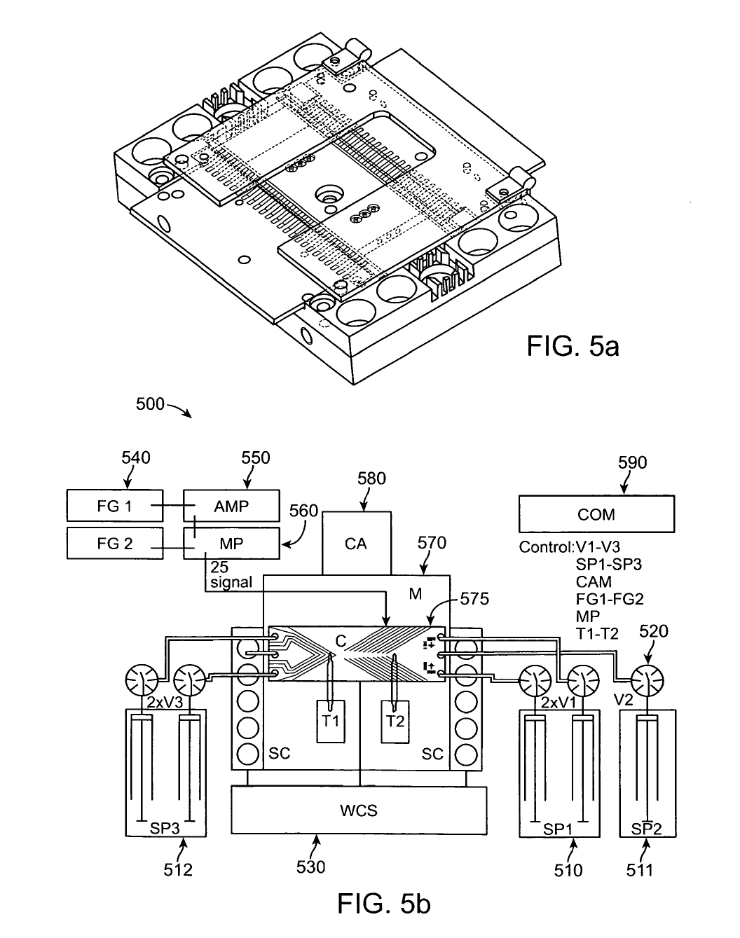

In some embodiments of the present invention, the dielectrophoretic fractionation device of the present invention is mounted into its fixture (see FIGS. 5a and 5b), which provides simultaneous fluidic and electric connection to the microfluidic controller periphery. The microfluidic controller setup 500 includes a fluorescence microscope (Eclipse E600FN, Nikon, Tokyo, Japan) fitted with a video camera 580. Precision syringe pumps (SP 210 IWZ, World Precision Instruments, Sarasota, Fla., USA) 510, 511 and 512 are connected to the sample and buffer inlets as well as to either a collecting buffer or waste outlet via HPLC 6- or 8-way valves 520 (Cheminert C5 2006D and Cheminert C5H 2008D, Vici A G, Schenkon, Switzerland). A device mount 570 is prepared allowing for simultaneous fluidic and electric connection of the device 575 to the periphery. In addition, the device mount and the bottom face of the channel can be cooled by means of a water-cooling system 530. The system is operated at 4-10° C. A function generator 540 (TG2000, TTi, Forth Worth, Fla., USA) provides the alternating current (AC) signals, which are amplified in a signal amplifier 550 (A303, AA Lab Systems, Ramat Gan, Israel) and distributed to the deflector units via a multiplexing unit 560 (AT34970A and AT34904A, Agilent Technologies Inc., Santa Clara, Calif., USA). The whole setup is controlled by a Lab view application 590 providing fully automated procedures including rinsing protocols and time controlled video acquisition in order to monitor long term fractionation processes.

Any air bubbles are removed from the channel by flushing with 70% ethanol. The ethanol is washed out of the system with deionized water and dielectrophoresis buffer. When the deflector units are coated, the coating can be accomplished, for example, by pumping a solution of 2 g/L bovine serum albumin (BSA) in dielectrophoresis buffer through the system at 6 μL/min for about four hours. Other methods of coating the deflector units are described above and are known to one of skill in the art.

After thorough rinsing of the system using 2 mL buffer and 6 mL deionized water at 10 μL/min for 400 mM, the sample is applied at the two outermost fluidic ports and flow rate is adjusted to 1 μL/min for each port. The protein content can be from 10 to 200 μg/mL. The collecting buffer supply is connected to the center fluidic port and operated at 0.9 μL/min. The flow pattern can be strictly laminar. The dielectrophoretic fractionation device, cell homogenate and mitochondria sample can be cooled at 4-10° C.

A mechanical actuator including a solenoid to strike the outside surface of the channel can be adjusted so as to induce a periodic flow pattern superimposed on the sample flow. Frequency and amplitude of the tapping movement are controlled by the LabView software.

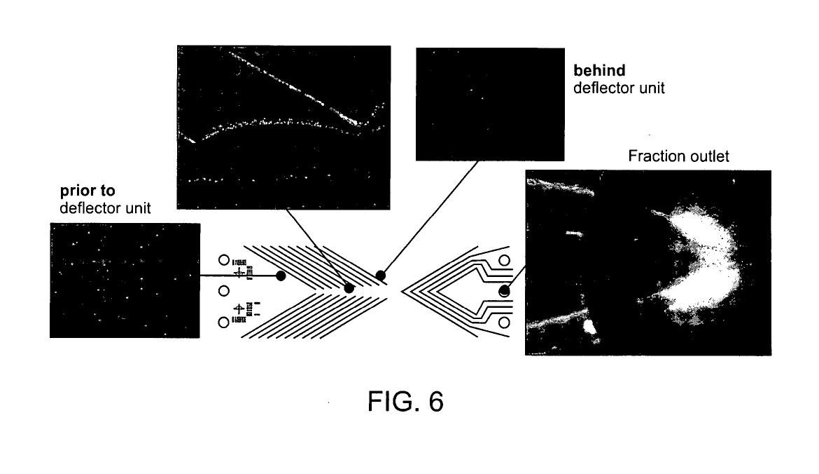

High frequency (HF) voltage is applied at the terminals of the deflector units and biological particles (mitochondria) are deflected into the collecting buffer flow. As shown in FIG. 6, the liquid particle suspension, prior to interacting with the electric field gradient of the deflector units, is evenly distributed with particles. At the deflector units, the particles to be isolated interact with the electric field gradient and are deflected along the length of the deflector units such that after passing beyond the deflector unit and the electric field gradient, the particles to be isolated travel to a collection point (fraction outlet). The liquid particle suspension that travels past the deflector units (as shown in the image behind the deflector unit) contains none of the particles to be isolated.

Periodically, every 10-30 minutes, the HF voltage is switched off by software control and the amplitude and frequency of the actuator are increased for a short period of time, for example about 10 seconds, in order to remove any debris or aggregates that might have formed on the deflector units during the separation period.

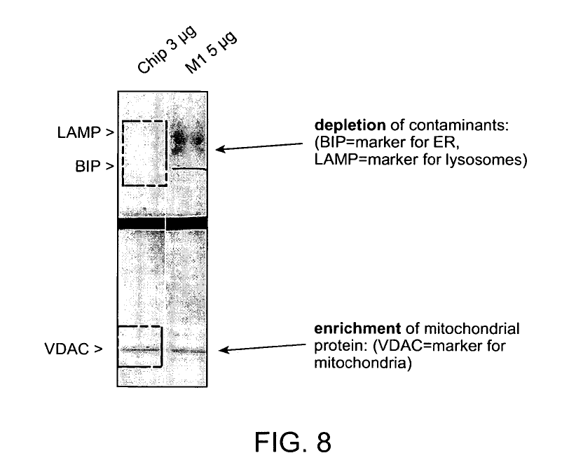

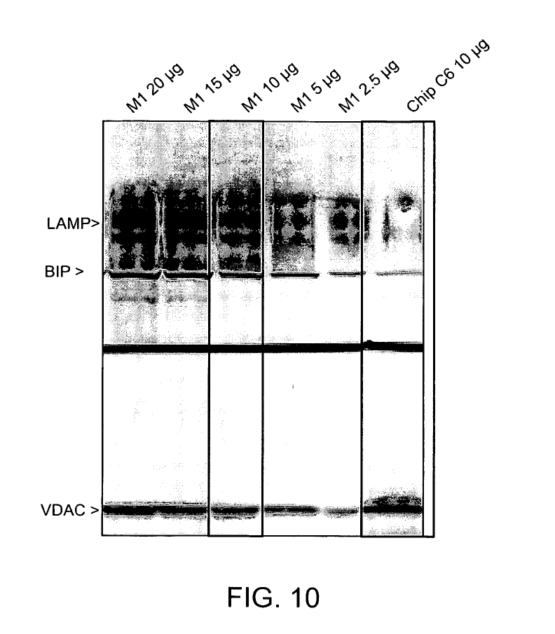

Using the sample prepared according the procedure above, the method of the present invention can fractionate the mitochondria of the sample. FIG. 8 shows the depletion of contaminants (BiP is a marker for endoplasmic reticulum, LAMP is a marker for lysosomes) and the accumulation of mitochondria (using VDAC as a marker) in the sample purified via the method of the present invention. (See also FIG. 10 showing depletion of BiP and LAMP with accumulation of VDAC.)

While the foregoing description describes various alternatives, still further alternatives will be apparent to those who are skilled in the art and are within the scope of the invention. In the claims appended hereto, the term “a” or “an” is intended to mean “one or more.” The term “comprise” and variations thereof, such as “comprises” and comprising,” when preceding the recitation of a step or an element, are intended to mean that the addition of further steps or elements is optional and not excluded. All patents, patent applications, and other published reference materials cited in this specification are hereby incorporated herein by reference in their entirety. Any discrepancy between any reference material cited herein or any prior art in general and an explicit teaching of this specification is intended to be resolved in favor of the teaching in this specification. This includes any discrepancy between an art-understood definition of a word or phrase and definition explicitly provided in this specification of the same word or phrase.

What is claimed is:

1. A dielectrophoretic fractionation device for the fractionation of particles in a liquid particle suspension, the device comprising:
a channel defining a direction of flow therethrough;
a deflector unit affixed to a wall of the channel and arranged to generate an electric field gradient in the channel to spatially separate the particles in the liquid particle suspension; and
an actuator mounted to the channel and positioned to deform the wall.

2. The dielectrophoretic fractionation device of claim 1, wherein the actuator is positioned to deform the wall downstream of the deflector unit.

3. The dielectrophoretic fractionation device of claim 1, further comprising a coating on the deflector unit to inhibit the interaction of the particles with the deflector unit.

4. The dielectrophoretic fractionation device of claim 3, wherein the coating is selected from the group consisting of bovine serum albumin and a polyethylene glycol polymer.

5. The dielectrophoretic fractionation device of claim 1, further comprising a heat sink affixed to a second wall of the channel.

6. The dielectrophoretic fractionation device of claim 5, wherein the second wall comprises a thermally conductive material.

7. The dielectrophoretic fractionation device of claim 5, wherein the second wall comprises silicon.

8. The dielectrophoretic fractionation device of claim 5, wherein the second wall comprises a thermally conductive polymer.

9. The dielectrophoretic fractionation device of claim 1, wherein the deflector unit is recessed in the wall.

10. The dielectrophoretic fractionation device of claim 1, wherein the height of the channel is from about 1 μm to about 100 μm, and the width of the channel is from about 500 μm to about 50 mm.

11. The dielectrophoretic fractionation device of claim 1, wherein the flow volume of the channel is from about 0.01 μL/min to about 1000 μL/min.

12. A method for inhibiting aggregation of particles in a liquid particle suspension of a dielectrophoretic fractionation device,
the device comprising
a channel defining a direction of flow therethrough, and
a deflector unit affixed to a wall of the channel and arranged to generate a field gradient in the channel to spatially separate the particles in the liquid particle suspension,
the method comprising periodically deforming the wall with an actuator mounted to the channel and positioned to deform the wall.

13. The method of claim 12, wherein the deformation occurs at a frequency of from about 0.1 Hz to about 100 Hz

14. The method of claim 12, wherein the actuator is positioned to deform the wall downstream of the deflector unit.

15. The method of claim 12, wherein the deflector unit is coated to inhibit the interaction of the particles with the deflector unit.

16. The method of claim 12, further comprising maintaining the temperature of the liquid particle suspension at from about 0° C. to about 40° C.
